(19) United States
(12) Patent Application Publication
(10) Pub. No.: US 2026/0155049 A1
(43) Pub. Date: Jun. 4, 2026

(54) METHOD AND SYSTEM OF AIRCRAFT GROUND NAVIGATION WITH INCREASED EFFICIENCY

(71) Applicant: HONEYWELL INTERNATIONAL INC., Charlotte, NC (US)

(72) Inventors: Gobinathan Baladhandapani, Madurai (IN); Karthikeyan M, Madurai (IN); Pradeep Huncha, Bangalore (IN); Srilakshmi Kurudi, Bangalore (IN)

(73) Assignee: HONEYWELL INTERNATIONAL INC., Charlotte, NC (US)

(21) Appl. No.: 19/072,240

(22) Filed: Mar. 6, 2025

(30) Foreign Application Priority Data
Dec. 2, 2024 (IN) 202411094728

(51) Int. Cl. G08G 5/265; G08G 5/21; G08G 5/30; G08G 5/51; G08G 5/72; G08G 5/80

(52) U.S. Cl. CPC G08G 5/265; G08G 5/21; G08G 5/30; G08G 5/51; G08G 5/727; G08G 5/80

(57) ABSTRACT

A method includes determining a target destination at an airside of an airport and of an aircraft, and receiving aircraft operating context data indicating a current state of the aircraft and including at least a current position of the aircraft. The method also includes receiving real-time ground operations data for the airport including instructions to move the aircraft to the target destination. The method includes determining ground navigation instructions by using both the real-time ground operations data and the aircraft operating context data. The ground navigation instructions recite a planned state of one or more engines of the aircraft. The method includes providing the ground navigation instructions in time to implement the ground navigation instructions so that the one or more engines of the aircraft are in the planned state at or before reaching the target destination as instructed by the ground navigation instructions.

### CROSS REFERENCE TO RELATED APPLICATION

This application claims priority to India Provisional Patent Application No. 202411094728, filed Dec. 2, 2024, the entire content of which is incorporated by reference herein.

### TECHNICAL FIELD

The subject matter described herein generally relates to aircraft operations, and more particularly relates to aircraft ground navigation at airports that provide higher efficiency.

### BACKGROUND

During aircraft operations at an airside of an airport, taxiway management systems are used to reduce the fuel consumption and taxiing time of an aircraft and can provide pilots with better ground situational awareness. It is desired, however, to provide a taxiway management system that takes better advantage of real-time data available to generate ground navigation plans relatively quickly and in time for implementation to further increase fuel efficiency and performance of the aircraft while reducing taxiing durations.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one implementation, a method includes determining, by at least one processor, a target destination at an airside at an airport and of an aircraft, and receiving aircraft operating context data indicating a current state of the aircraft and including at least a current position of the aircraft. The method also includes receiving real-time ground operations data for the airport and from at least one real-time data source including instructions to move the aircraft to the target destination. The method includes determining, by at least one processor, ground navigation instructions by using both the real-time ground operations data and the aircraft operating context data. The ground navigation instructions recite a planned state of one or more engines of the aircraft. The method includes providing the ground navigation instructions in time to implement the ground navigation instructions so that the one or more engines of the aircraft are in the planned state at or before reaching the target destination as instructed by the ground navigation instructions.

In another implementation, a system includes memory, and processor circuitry forming at least one processor communicatively coupled to the memory and being arranged to operate by determining a target destination at an airside at an airport and of an aircraft, and receiving aircraft operating context data indicating a current state of the aircraft and including at least a current position of the aircraft. The processor is arranged to operate by receiving real-time ground operations data for the airport and from at least one real-time data source including instructions to move the aircraft to the target destination, and determining ground navigation instructions by using both the real-time ground operations data and the aircraft operating context data. The ground navigation instructions recite a planned state of one or more engines of the aircraft. The planned state is at least one of a thrust level or a power on/off state. The processor is arranged to operate by providing the ground navigation instructions in time to implement the ground navigation instructions so that the one or more engines of the aircraft are in the planned state at or before reaching the target destination as instructed by the ground navigation instructions.

In yet another implementation, a non-transitory computer-readable medium includes instructions thereon that when executed by a computing device, cause the computing device to operate by receiving an end-destination at an airside of an airport and a route from a current position of an aircraft and to the end-destination, and determining at least one target destination along the route and of the aircraft, The instructions also cause the computing device to operate by receiving aircraft operating context data indicating a current state of the aircraft, and receiving real-time ground operations data for the airport and from at least one real-time data source including instructions to move the aircraft to the target destination. The instructions also cause the computing device to operate by determining ground navigation instructions by using both the real-time ground operations data and the aircraft operating context data. The ground navigation instructions recite a planned state of one or more engines of the aircraft. The instructions also cause the computing device to operate by providing the ground navigation instructions in time to implement the ground navigation instructions so that the one or more engines of the aircraft are in the planned state at or before reaching the target destination as instructed by the ground navigation instructions.

Furthermore, other desirable features and characteristics of the disclosed implementations will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a schematic diagram of an example aircraft system according to at least one of the implementations disclosed herein;

FIG. 2A is a schematic diagram of an example real-time ground navigation guidance system according to at least one of the implementations disclosed herein;

FIG. 2B is a schematic diagram of an example taxi model used by the system of FIG. 2A according to at least one of the implementations disclosed herein;

FIG. 3 is a flow chart of an example method of ground navigation using real-time data according to at least one of the implementations disclosed herein;

FIG. 4 is a flow chart of an example method of ground navigation using real-time data to plan a rolling stop according to at least one of the implementations disclosed herein;

FIG. 5 is a flow chart of an example method of ground navigation using real-time data to plan an expedited crossing according to at least one of the implementations disclosed herein;

FIG. 6 is a flow chart of yet another example method of ground navigation using real-time data to plan single engine taxiing according to at least one of the implementations disclosed herein;

FIG. 7 is a schematic diagram of an overhead view of an airport airside according to at least one of the implementations disclosed herein;

FIG. 8 is a schematic diagram of an overhead view of an airport airside intersection according to at least one of the implementations disclosed herein;

FIG. 9 is an image for a display device on an aircraft to show ground navigation guidance according to at least one of the implementations disclosed herein; and

FIG. 10 is a schematic diagram of an overhead view of an airport runway with an aircraft using single engine taxiing according to at least one of the implementations disclosed herein.

### DETAILED DESCRIPTION

The following detailed description is merely on example and is not intended to limit the subject matter of the application and uses thereof. Furthermore, there is no intention to be bound by any expressed or implied theory presented in the preceding technical field, background, brief summary, brief description of drawings, or the following detailed description.

The disclosed method and system receives data of the airside context of an airport in real-time to quickly generate customized ground navigation instructions that can reduce fuel consumption and time delays while taxiing. The disclosed method provides guidance instructions for an aircraft to a roll to a stop at idle thrust by indicating the start point for the idle thrust while taxiing. Another guidance instruction includes an expedite instruction that informs the aircraft to accelerate to a higher speed to cross runways or taxiways in the situation where remaining at a lower speed may cause delay caused by other aircraft traffic blocking the route of the ownship receiving the instructions. Yet another guidance instruction may inform an aircraft of a location point to start a second engine during single engine taxiing and just in time for using the second engine to accelerate for take-off. The methods and systems disclosed herein accomplish the generation of this guidance by receiving various real-time ground context of the airside including audio and/or datalink clearance messages, traffic reports, and so forth, as well as the operational context (or profile) of the aircraft being analyzed including the aircraft position, speed, route, and destination point, target time of arrival at the destination point, and so forth. The system has a guidance unit that receives the factor data and determines the current traffic and aircraft status, and the appropriate category of instructions to provide the aircraft with the three (or more) options mentioned above. Thereafter, a taxi model computes the distances involved from the current position of the aircraft to the location where the aircraft must perform an action (increase thrust, decrease or turn off thrust, or turn on an engine). The instructions are then displayed to the aircraft crew. Alternatively, the FMS, autopilot, and/or autothrust systems of the aircraft may receive the instructions and implement the instructions autonomously. The term ‘real-time’ used herein relates to the timing of the collection of the airside operation data. The instructions for the aircraft may be provided immediately or may be delayed so that the aircraft receives the instructions in time to implement the instructions at or before a next holding point or take-off point at the airside (referred to as a target destination).

It should be noted herein, the area of an airport where aircraft can move on the ground is referred to as the airside of the airport, where the airside may include both a movement area and a non-movement area. The movement area includes taxiways and runways that is often controlled by an airport tower and/or an ATC, and the non-movement area includes an apron (or ramp or tarmac) that has the gates of the airport terminals, and an aircraft may be permitted to move without airport tower and/or ATC instructions.

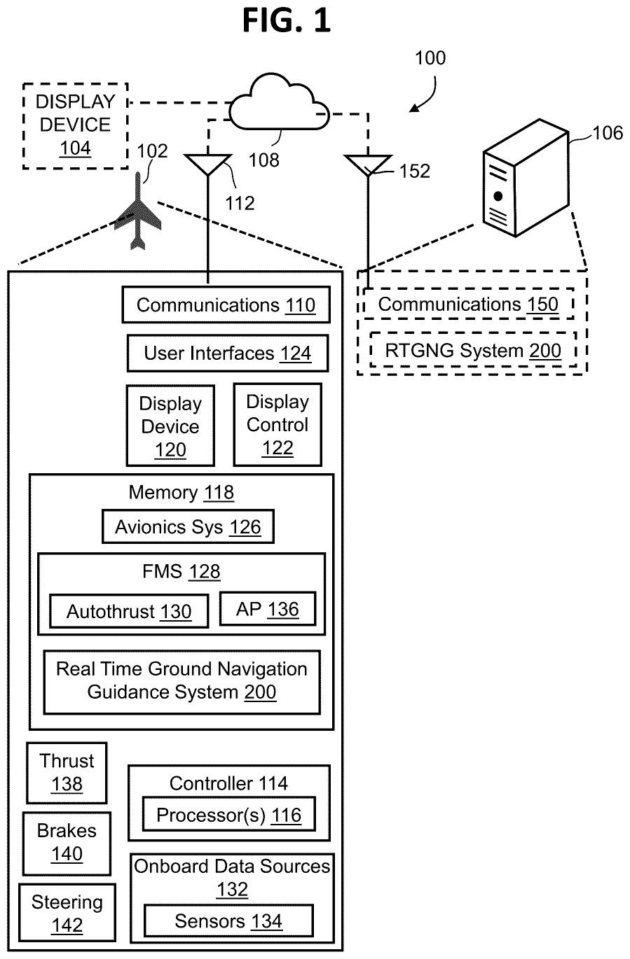

Referring to FIG. 1, an example aircraft system 100 is in accordance with the disclosed implementations. The aircraft system 100 includes at least one aircraft 102. By some alternatives, an optional separate mobile display device 104, such as a tablet or electronic flight bag (EFB) may be used as an alternative to using a display device 120 on the aircraft and as described below.

Also by another alternative, at least one remote system 106 may be used and that is located at a ground airline or vehicle control center or base, an airline flight operation (FlightOps) base, a dispatch team base, a maintenance base (or ground maintenance), and so forth. In addition to the forms mentioned below, the remote system 106 may be realized as a cloud or remote information technology (IT) or control center, or otherwise as a maintenance or software update data center or a distributed network of remote control centers that reside at geographic locations that are separate and distinct from one or more edge computing systems that communicate directly with a controller on the aircraft 102.

The system 100 also may include a real-time ground navigation guidance (RTGNG) system 200 to increase fuel efficiency, reduce delay, and increase performance during taxiing as described herein. The aircraft 102 may include any number and type of aircraft including an airplane, helicopter, spacecraft, hovercraft, or the like, and is not particularly limited as long as the aircraft has the systems to be used with ground navigation guidance described herein.

The aircraft 102 may include a controller 114 operationally coupled to computer-readable storage media or memory 118, onboard data sources 132 including, for example, an array of sensors 134, and a communications system 110 including an antenna 112, which may wirelessly transmit data to and receive data from various external sources physically and/or geographically remote to the aircraft 102 such as the remote system 106 and an ATC. The aircraft 102 also may have one or more of the aircraft display devices 120, one or more display control units 122, and one or more user interfaces 124 that may use graphical user interfaces (GUIs) on the aircraft display device 120.

The memory 118 may hold or store a flight management system (FMS) 128 with an autothrust unit 130 and an autopilot unit 136, other avionics systems 126 described herein, and the real-time ground navigation guidance system 200, or portions thereof, on the aircraft 102 rather than solely on the mobile device 104 or at the remote system 106.

The aircraft 102 also has a thrust unit 138 including the thrust levers or other activator in a cockpit and that drive the engines on the aircraft, a brakes unit 140 that include the brakes on wheels of the landing gear of the aircraft 102 and the controls thereof, and a steering unit 142 that includes the ground steering tiller, other steering controls, and so forth. The thrust unit 138, brakes unit 140, and steering unit 142 also may include the circuitry used to autonomously or manually control the thrust, brakes, and steering components of the aircraft 102.

The remote system 106 may include a communications unit or system 150 and an antenna 152, which may wirelessly transmit data to and receive data from various external sources physically and/or geographically remote to the remote system 106, such as to receive monitored data from the aircraft and transmit ground navigation (GN) procedures to the aircraft 102 or the mobile display device 104 as described herein. Otherwise, the remote system 106 may have the processors, memory, and programs to entirely or partially operate a real-time ground navigation guidance system 200 as described with the system 200 on aircraft 102.

Although schematically illustrated in FIG. 1 as a single unit, the individual elements and components of the system 100 can be implemented in a distributed manner utilizing any practical number of physically distinct and operatively interconnected pieces of hardware, equipment, nodes, or sites.

The term “controller,” as appearing herein, broadly encompasses those components used to perform or otherwise support the processing functionalities of the system 100. Accordingly, the controller 114 can encompass or may be associated with circuitry forming any number of individual processors, computer-readable memories, databases, power supplies, storage devices, interface cards, and other standardized or customized components.

In various implementations, the controller 114 includes processor circuitry forming at least one processor 116, a communication bus (not shown), and a computer readable storage device or media. The processors 116 perform the computation and control functions of the controller 114. The processors 116, and the controller 114, may form or be part of an avionic server or gateway server. The processors 116 can be any custom made or commercially available processor, a general purpose processor, a central processing unit (CPU), a graphics processing unit (GPU), a digital signal processor (DSP), an auxiliary processor among several processors associated with the controller 114, a semiconductor-based microprocessor (in the form of a microchip, chip set, system on a chip (SoC)), multiple processor cores, an application specific integrated circuit (ASIC), a field programmable gate array (FPGA) or other programmable logic device, discrete gate or transistor logic, discrete hardware components, or any combination thereof designed to perform the functions described herein. By one form, the controller 114 may be, or have, one or more processors and other computing components on one or more servers, computers, laptops, desktops, and/or mobile devices such as tablets, smartphones, and so forth, and this may include cloud-based servers.

The memory 118 may include computer readable storage devices or media such as volatile and nonvolatile storage in read-only memory (ROM), random-access memory (RAM), flash memory, registers, and cache. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 114. The bus serves to transmit programs, data, status and other information or signals between the various components coupled to the controller 114. The bus can be any suitable physical or logical means of connecting computer systems and components. This includes, but is not limited to, direct hard-wired connections, fiber optics, infrared, and wireless bus technologies.

The executable instructions may include or establish one or more separate programs, each of which comprises an ordered listing of executable instructions for implementing logical functions. The instructions, when executed by the processor, perform logic, calculations, methods and/or algorithms, and generate data based on the logic, calculations, methods, and/or algorithms. Although only one of the controllers 114 is shown in FIG. 1, implementations of the system 100 can include any number of controllers 114 that communicate over any suitable communication medium or a combination of communication media and that cooperate to perform logic, calculations, methods, and/or algorithms, and generate data. In various implementations, the controller 114 includes or cooperates with at least one firmware and software program (generally, computer-readable instructions that embody an algorithm) for performing the various process tasks, calculations, and control/display functions described herein. During operation, the controller 114 may be programmed with and execute at least one firmware or software program. This may include programs or applications stored in memory 118 as described below. Each of these units may have or use a database that is considered part of memory 118 or another memory.

The controller 114 may exchange data with one or more external sources to support operation of the system 100 in various implementations. In this case, bidirectional wireless data exchange may occur via the communications systems 110 and 150 or other remote systems over a communications network 108, such as a public or private network implemented in accordance with Transmission Control Protocol/Internet Protocol architectures or other conventional protocol standards. Encryption and mutual authentication techniques may be applied, as appropriate, to ensure data security.

In various implementations, each of the communications systems 110 and 150 are configured to support instantaneous (i.e., real-time or current) communications between various systems. The communications systems 110 and 150 may each incorporate one or more transmitters, receivers, and the supporting communications hardware and software required for components of the system 100 to communicate as described herein. The network 108 used for communication may be a wireless gateway such as a data link management wireless (DLM-W) system that provides communication among systems within a cockpit and on an aircraft as well as transmission between the aircraft and the ground, Aircraft Communication Addressing and Reporting System (ACARS), which uses VHF, HF, or satellite communication (SATCOM) (whether via Wi-Fi or other network), VHF Data Link (VDL), High-Frequency Data Link (HFDL), and air-to-ground (ATG) systems. Other networks may be used when the aircraft 102 is on the ground such as cellular networks and ground Wi-Fi Networks while an aircraft is at a gate, taxiing, or at a remote location on the ground from a specific maintenance base. Any combination of these may be used. In various implementations, one or both the communications systems 110 and 150 may include additional communications not directly relied upon herein, such as bidirectional pilot-to-ATC (air traffic control) communications via a datalink, and any other suitable radio communication system that supports communications between the aircraft 102 (and/or the remote system 106) and various external source(s). The communications described herein also may apply to transmission to the display devices where suitable.

The memory 118 can encompass any number and type of storage media suitable for storing computer-readable code or instructions, such as the applications or units mentioned above as well as other data generally supporting the operation of the system 100. As can be appreciated, the memory 118 may be part of the controller 114, separate, or both.

Returning to the aircraft 102, the onboard data sources 132 supply various types of data and/or measurements to the controller 114 so that the various avionics systems can generate relevant parameters, such as the state and condition of the aircraft 102 including the current states of the flight components, equipment, thrusters of the thrust unit 138, brakes of the brakes unit 140, steering control or tiller of the steering unit 142, engines, and so forth on the aircraft 102. The parameters or flight operations described herein also may include any flight control settings including for the thrusters and any other unit or component of the aircraft 102, as well as avionics value settings at each of the avionics systems, such as autopilot, autothrust, or real pilot input values (or default values) for various parameters such as speed, altitude, and so forth. Thus, the monitoring of avionic systems 126 such as the autopilot, autothrust, navigation, and/or flight management systems (FMS) 128 to name a few examples may be monitoring real-time task execution. The onboard data sources 132 may use an array of sensors 134 of various types to detect the actual condition or position of the components and equipment on the aircraft. The details and operation of the types of sensors 134 are not needed for the understanding of the disclosed system and method.

In example implementations, the aircraft display device 120 is an electronic display capable of graphically displaying flight information or other data associated with operation of the aircraft 102. The aircraft display device 120 is communicatively coupled to, and controlled by, the display control unit 122 and/or processors 116. In this regard, the processors 116 and the display control unit 122 are cooperatively configured to display, render, or otherwise convey one or more graphical representations or images associated with operation of the aircraft 102 and relevant here, optionally can display GN guidance procedures or instructions on the aircraft display device 120, as described in greater detail below. Generally, aircraft display devices 120 visually convey a considerable amount of situational information for pilots. The displayed information is sourced from various databases, sensors, transponders, broadcasts, and FMS computations. The information is often organized in “information layers” (e.g., flight path information, Navigational Aids (NAVAID), airspace information, terrain information, weather information, traffic information, etc.). The various information layers are combined to provide a unified graphical display on the avionics display device 120.

In various implementations, the aircraft display device 120 may be a multifunction control display unit (MCDU), cockpit display device (CDU), primary flight display (PFD), primary engine display (PED), multi-function display (MFD), navigation display (ND) which may include a horizontal situational display (HSD) or horizontal situation indicator (HIS), a vertical display that displays vertical trajectories or profiles (or data of vertical trajectories), or any other suitable multifunction monitor or display suitable for displaying various symbols and information described herein. The aircraft display device 120 may be configured to support multi-colored or monochrome imagery, and the aircraft display device 120 may have a cathode ray tube (CRT) display, flat panel displays such as LCD (liquid crystal displays) and TFT (thin film transistor) displays or other LCD displays, a light emitting diode (LED) display, an organic light emitting diode (OLED) display, a heads-up display (HUD), a heads-down display (HDD), a plasma display, a projection display, a cathode ray tube (CRT) display, or the like. The display system may comprise display devices that provide three dimensional or two dimensional images and may provide synthetic vision imaging. Accordingly, each display device responds to a communication protocol that is either two-dimensional or three, and may support the overlay of text, alphanumeric information, or visual symbology.

The user interfaces 124 (or user input interface) are coupled to the processors 116, and the user interface 124 and the processors 116 are cooperatively configured to allow a user (e.g., a pilot, or crew member) to interact with the aircraft display device 120 and/or other elements of the system 100. Depending on the implementation, the user interface 124 may be a keypad, touchpad, keyboard, mouse, touch panel (or touchscreen), joystick, yoke, steering wheel, knob, line select key, or another suitable device adapted to receive input from a user. These interface devices are on or part of aircraft display device 120, or are wired or wirelessly connected to the aircraft display device 120 (or are optionally used with mobile display device 104). This may include any controller or input device for controlling the motion of the aircraft. In some implementations, the user interface 124 is, or includes, an audio input device, such as a microphone, audio transducer, audio sensor, or the like, accompanied with audio speech recognition and other software to input commands to the FMS 128 or to transcribe incoming audio messages, or other system or unit on the aircraft for example. In some implementations, the user interface 124 is a tactile user input device such as with touchpads or touch screens, stylus, pen, or the like.

The display control unit 122 has the hardware, firmware, processing logic and/or other components configured to control the display and/or rendering of one or more displays pertaining to operation of the aircraft 102 and/or avionics systems 126 and FMS 128 described below, and displays on the aircraft display device 120 (e.g., synthetic vision displays, navigational maps, HSDs, vertical profile (trajectory) displays, and the like). Also, the display control unit 122 may access or include one or more avionics databases (not shown) to generate image data for displays.

Still referring to FIG. 1, in one or more example implementations, the processors 116 on the aircraft 102 are coupled to the avionics systems including the FMS 128, the communications systems 110, as well as other avionics systems 126 such as a navigation unit or system, and one or more additional avionics units to support navigation, flight planning, and other aircraft control functions, as well as to provide real-time data and/or information regarding both the operational status of the aircraft 102 and the real-time airside context to the processors 116. It should be noted that the system 100 and/or aircraft 102 will likely include numerous avionics systems for obtaining and/or providing real-time flight-related information that may be displayed on the aircraft display device 120 or otherwise provided to a user (e.g., a pilot). For example, practical implementations of the aircraft system 100 and/or aircraft 102 will likely include one or more of the following avionics systems 126 suitably configured to support operation of the aircraft 102: a weather system, an air traffic management system, a radar system, a traffic avoidance system, an autopilot system, an autothrust system, a flight control system, hydraulics systems, pneumatics systems, environmental systems, electrical systems, engine systems, trim systems, lighting systems, crew alerting systems, electronic checklist systems, an electronic flight bag (EFB), an automatic dependent surveillance-Broadcast (ADS-B) system, and/or any other suitable avionics system. Each of these avionics systems or unit may include and/or use a database suitably configured to support operations of the avionics system 126 such as a terrain database, an obstacle database, an air restriction database, a navigational database, a geopolitical database, a terminal airspace database, a special use airspace database, and so forth for generating, rendering, and/or displaying navigational maps and/or other content on the aircraft display device 120 or to store and find other aircraft related data.

The FMS 128 may be configured to provide real-time navigational data and/or information regarding the operation of the aircraft 102 both to the pilot and to be transmitted to monitoring systems such as the avionics system unit 158 at the remote system 106. The FMS 128 and similar systems receive input from various sources including an ATC, the pilots, sensors, the navigation databases mentioned, and so forth, and uses the inputs to compute flight plans including horizontal and vertical trajectories. The output showing a flight plan is then displayed or otherwise provided to the aircrew, and this may include flight information including waypoints, altitudes, airspace limitations, airspeed settings, and so forth. This data may be used to set ground navigation procedures when relevant, such as an estimated time of arrival (ETA) or estimated time of takeoff (ETT) at a particular airport runway. The FMS 128 also may provide avionic display pages to be shown on the aircraft and that provide a moving map of the airport airside.

The FMS 128 may have an autothrust 130 and/or autopilot 136 that may autonomously set thrust levels directly based on real-time GN guidance instructions from the RTGNG system 200. Otherwise, a user or pilot may be informed of the instructions via display 120 or other display or interface, and then manually set the thrusters or set the FMS autothrust unit 130 to set the thrusters according to the instructions.

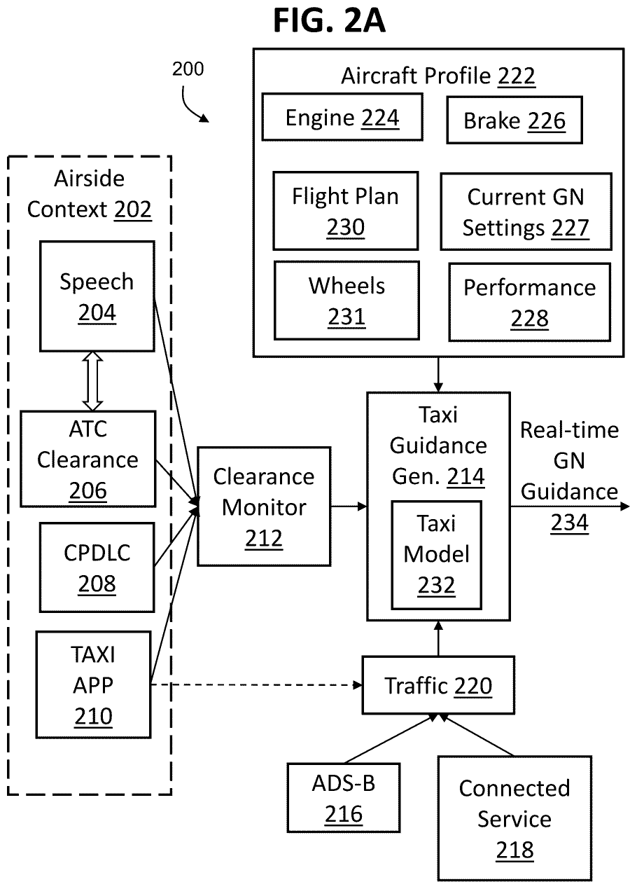

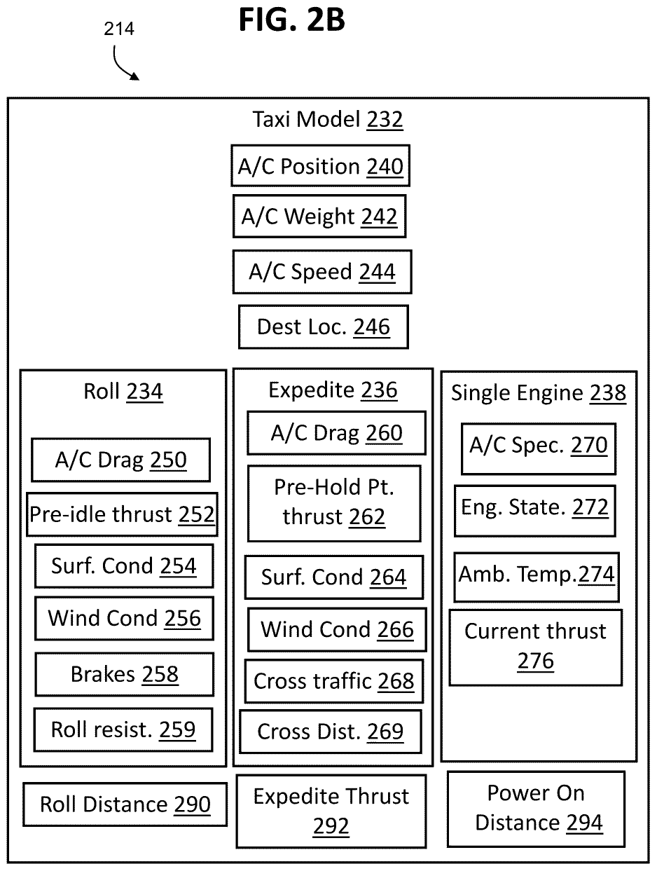

Referring to FIG. 2A, the example RTGNG system 200 may have data collection units, collectively referred to as airside context (or real-time ground operations) unit 202 that receive data regarding the current (or real-time) context or state of the airside of the airport and including data of audio or digital clearances received from an external entity such as an ATC. By one example form, the RTGNG system 200 also may have a clearance monitor unit 212, an aircraft profile (or aircraft operating context) unit 222, and traffic unit 220 that collects traffic data from other external sources. The airside context (or ground operations) units 202 may include an ATC clearance (or clearance-type) unit 206 to handle audio messages, a speech unit 204 to recognize speech in the clearances, a Controller-Pilot Data Link Communications (CPDLC) unit 208 that handles datalink or digital messages, and a taxi applications unit 210 that generates and tracks taxi routes for the aircraft on the airside. The traffic unit 220 collects traffic data from an ADS-B unit 216 and other connected communication services 218. The aircraft profile unit 222 may have an engine unit 224, a brake unit 226, a current GN settings unit 227, a performance unit 228, and a flight plan unit 230.

Thus, by one form, data from the airside context unit 202 and the traffic unit 220 form the real-time ground operations data indicating the state of the airside of the airport, while the aircraft profile unit 222 provides the current aircraft operational state of the aircraft (or ownship), but also may have data of received instructions for traveling on the airside. The data of the airside context unit 202, the traffic unit 220, and the aircraft profile unit 222 is provided to the taxi guidance generation unit 214 that determines which GN instructions to provide and then uses a taxi model 232 to determine the content of the GN instructions that is then provided for display or autonomous (or automatic) implementation at the aircraft. The details of these units are as follows.

The ATC clearance unit 206 and the CPDLC unit 208 respectively receive audio and digital (or datalink) messages from the ATC or other entity providing ground navigation guidance or instructions to the aircraft, and including operational messages, relevant here, such as ground navigation routes on the airside, clearances for holding points, runway entries, ground navigation route modifications, weather information, and so forth. It should be noted that the captured messages at the ownship aircraft 102 and airside context units 202 may be between the ATC (or tower or other entity) and any aircraft on or approaching the airport airside to attempt to obtain a complete understanding of the traffic at the airside, and this may be a continuous process.

The speech unit 204 receives audio messages from the ATC clearance unit 206 and performs automatic speech recognition (ASR) including any needed voice recognition to capture the audio input using a microphone and converts it into a digital waveform, performs key feature extraction, decoding such as with a Weighted Finite State Transducer (WFST) or other neural network, language modeling, and post-processing techniques including grammatical corrections and handling of domain-specific terminologies. By one example form, the recognized words (and numbers) are then passed to the clearance monitor unit 212 for deeper understanding of the messages, although the speech engine may perform these tasks as well.

A taxi applications unit 210 may provide data of airside routes provided to the aircraft at the airside. This may include Surface Management Systems (SMS), such as the Airport Surface Detection Equipment Model X (ASDE-X), which provides real-time surveillance of airport surfaces to guide aircraft along safe routes. Also, an Advanced Surface Movement Guidance and Control Systems (A-SMGCS) integrates radar and GPS to offer precise routing information for aircraft.

The clearance monitor unit 212 receives the clearance and airside context data and may perform semantic or natural language recognition to specifically recognize aircraft and airside-related terminology including airside instructions, commands, requests, ground navigation parameters, and so forth in the received messages that is relevant to the ground navigation of any of the aircraft at the airside. This may include messages of clearances that indicate current positions, target destinations (such as holding points and runways), and so forth, and of all aircraft at the airside. This is included in the airside context (or ground operations data) as the airside context, which is then provided to the taxi guidance generation unit 214.

Traffic data from the traffic unit 220 also may be provided to the taxi guidance generation unit 214. The traffic unit 220 may obtain the traffic data from the ADS-B unit 216 to receive position, velocity, and other ground navigation data of each non-ownship aircraft at the airside. This also may include data identifying the aircraft type, call sign, and other specifications to identify a specific aircraft. The connected services unit 218 may receive data from a Global Navigation Satellite System (GNSS) for positioning and transmits data via a VHF radio frequency or UHF to nearby aircraft, providing pilots with situational awareness of other planes on the ground. Additionally, Multilateration (MLAT) and radar systems such as Surface Movement Radar can also provide traffic data via datalink communications or via Automatic Terminal Information Service (ATIS) in the cockpit giving pilots critical updates on an airside situation.

Also, the connected services 218 may include connection with an advanced surface movement guidance and control system (ASMGS) system. The ASMGS system is a ground guidance control system that may collect data related to tracking of aircraft positions and movement patterns on the airside, and potential and actual conflicts between aircraft ground routes and between other ground vehicles and aircraft. This may include instructions and monitoring of aircraft to maintain sufficient separation between the aircraft while performing ground navigation for all of the varying types of aircraft that may be on an airport airside. This also may include data identifying the aircraft type, call sign, and other specifications to identify a specific aircraft.

The traffic unit 220 may gather the traffic data from the ADS-B, connected services, and the Taxi applications 210 when relevant, and this may be performed continuously so at any point in time, the traffic unit 220 understands the situation at the airside. This may include having knowledge of each aircraft position, direction of travel, paths (runways or taxiways), as well as the time any aircraft will enter any of the intersections, holding points, hold-short lines, line-up positions, takeoff position, touchdown zone, and so forth. The traffic data is then provided to the taxi guidance generator unit 214.

The units (or sub-units) of the aircraft profile unit (or current aircraft operating context unit) 222 may be coupled to sensors and/or avionics systems as mentioned above to receive sensor data that indicates the state of the components, properties, position, motion, and other characteristics of the aircraft. The engine unit 224 may provide the specifications of the engines for aircraft type and specific aircrafts as well as the state of the engines of an aircraft including thrust levels (or idle), power on/off state, and so forth.

The brake unit 226 may have the specifications of the brakes for aircraft type and specific aircraft as well as the type and state of the brakes of an aircraft at certain time points, such as a percentage or level of brake force or psi, whether manual or auto-braking, to name a few examples. This may include the mechanical brakes on the aircraft wheels or reverse thrusters. Monitoring the brakes may indicate if speed of the aircraft before approaching the airside or target destination may be affected by the brakes.

The wheels unit 231 may provide the monitored state of the wheels of an aircraft to also provide the wheel type, dimensions, and landing gear configuration for a type of aircraft and a specific aircraft as well as provide a state of the wheels at a certain time point corresponding to a time point of clearance instructions and flight control settings. This may include a wheel pressure, a landing gear state, wheel motion (spinning, speed, and direction or angle for turning wheel(s)), and so forth. The wheels unit 231 also may have a braking and/or landing gear control system that may provide a rolling resistance (or rolling friction). Thus, the wheel state and specifications may be used to compute roll resistance caused by the wheels.

The current GN settings unit 227 may provide flight controls data being used before or during ground navigation while approaching or at the airside, respectively, and that indicate the actual position and motion of the aircraft as well as the actual state of the aircraft components being controlled. This may include brake, thruster, tiller, and rudder pedals (or other steering wheel or control) settings, fuel and engine controls, and so forth. In some example forms, the state of the aircraft components can be compared to the flight control settings and clearance to confirm the alignment of the aircraft components.

The flight plan unit 230 provides data from the FMS 128 or other avionics systems on the aircraft. This may include a taxi route integrated with airport data to suggest efficient taxi paths based on the aircraft's departure gate and current airport conditions, as well as target parameters of flight plans and actually executed parameters, including those in the air on approach and landing, and/or those used during ground navigation. This may include parameters such as aircraft position on the airside, speed, fuel consumed or burnt, time points such as a target time to take-off and an actual time to take-off, as well as multi-function display (MFD) mapping which may provide a display page or image of taxiway views and aircraft positioning and motion on an airport airside.

The FMS 128, and in turn the flight plan unit 230, or other avionics systems included herein may have or communicate with an air data computer (ADC) system, the performance unit 228, or other diagnostic avionics system that provides the aerodynamic drag of the aircraft as well including values representing the profile of the aircraft and the current state of the mechanisms affecting the drag including flap positions, and so forth. Otherwise, the FMS 128 and flight plan unit 230 may communicate with an electronic weight and balance system (EWBS) or other aircraft systems that uses sensors, other systems external to the aircraft, or other systems that manually, by pilot load sheet systems for example, compute the weight of the aircraft.

Also, the FMS 128 and flight plan unit 230 also may collect airside data from any other system being used off-board at an airport or on-board an aircraft that monitors the airside aircraft and provides guidance, routing, airside mapping, and so forth to increase situational awareness at the airside and by pilots or off-board personnel such as at the air traffic towers of the airport or other control center.

The performance unit 228 tracks the performance of the aircraft during airside travel, such as fuel efficiency, and by one example form, can provide data to the display device 120 to display how much fuel is being saved by the implemented taxiing processes disclosed herein as described below.

Any of the data providers including any of the airside context data of airside context unit 202, the traffic data 220, and/or the aircraft profile unit 222, may include weather data from external weather services that may be part of the connected services at 218, or may provide weather information from clearances 206/208, and/or as part of the flight plan unit 230, a weather unit as part of the aircraft profile unit 222, or another unit on the aircraft. Such weather information may include ambient temperature, wind direction and speed, as well as airside climate conditions such as airside surface conditions (e.g., ice, rain, and so forth).

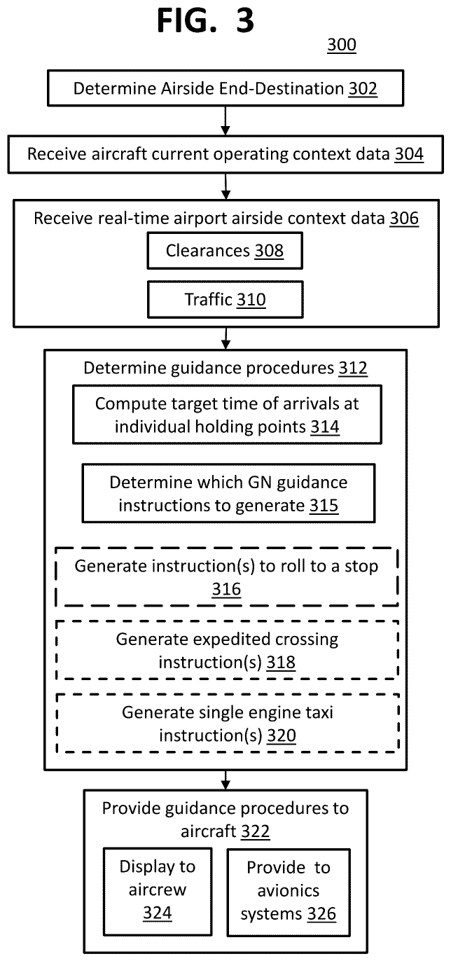

Referring to FIG. 2B, all of this data is provided to the taxi guidance generator unit 214 to first determine if any of the GN guidance instructions disclosed herein can be implemented for a specific aircraft, and then operate a taxi model 232 to perform the appropriate GN guidance instructions. The taxi guidance generator unit 214 determines which GN guidance instructions to implement as explained below with overall process 300 (FIG. 3).

The taxi model 232 may be pre-trained with the layout of the airside of a specific airport including the labels for each taxiway, runway, and so forth, as well as taxiway operations used for a particular airport, the status or availability of the taxiways, taxiways with particular purposes such as with rapid exit taxiways, and so forth. This airport operation data may be obtained from a number of sources provided by the airport itself or other entities.

The taxi model 232 may have various units that each handle a different parameter or variable to be used to compute a distance and/or thrust level to be provided as part of GN guidance instructions. In the present example, the taxi model 232 includes roll units 234, referring to a roll to a stop at idle thrust, expedite units 236 where an expedite clearance refers to an expedite instruction for an aircraft at a holding point or hold short location to cross a runway or taxiway rather than stop, and single engine units 238 to power on a second engine in time for the second engine to be used at takeoff. Each of these GN guidance instructions has a computation unit to use the parameters or factors, and compute a distance or thrust level to be provided as GN instructions to an aircraft. Thus, the taxi model 232 has a roll distance unit 290, an expedite thrust unit 292, and a power on distance unit 294 to perform these computations.

In more detail, the taxi model 232 has units for receiving and using a number of parameters used for multiple or any of the GN guidance instructions. These factors 240 to 246 may be referred to as universal factors and include an aircraft (A/C) position unit 240, an A/C weight unit 242, an A/C speed unit 244, and a current A/C thrust level (not shown). Otherwise, roll units 234 provide roll to stop factors or parameters to compute a roll to stop distance from an airside or target destination. The roll to stop distance is from a roll to stop point (or idle thrust point) before the roll to stop target destination where an aircraft moving toward the roll to stop destination is to set thrusters to idle to roll to a stop or coast to a stop at the roll to stop target destination. The target destination may be a holding point or hold short location, and including a point on a runway or taxiway.

The roll to stop factors (or units) may include, or are handled by, an A/C drag unit 250, a pre-idle thrust unit 252, a surface conditions unit 254, a wind conditions unit 256, a brakes unit 258, and a roll resistance unit 259. The pre-idle thrust unit 252 provides the latest thrust level before an aircraft reaches the idle thrust stop since the difference between the starting thrust level before changing to idle can affect the roll to stop distance. Also, the surface conditions unit 254 provides factors for ice or rain on the pavement of the airside that affects the roll to stop distance. In addition, the brakes unit 258 provides factors indicating any non-zero wheel brake levels, or brake system factors that would decrease or increase the roll to stop distance. The wind conditions unit 256 factors the wind speed and direction against the aircraft, while the roll resistance unit 259 factors roll resistance depending on wheel characteristics (or parameters, etc.) such as tire pressure, and so forth. Any one or more of these factors may be used in the roll to stop computations.

The roll distance unit 290 may use a kinetic energy equation or other equation to compute the distance from the idle thrust point to the target destination, and while the aircraft is at an initial aircraft velocity just as the aircraft reaches or is at the idle thrust point. The velocity is factored or weighted by at least some of the roll to stop factors or roll units 234 and the universal factors 240 to 246 that either detract from the momentum or add to the momentum of the aircraft as the aircraft travels from the idle thrust point to the airside or target destination.

The expedite factors or units 236 use many of the same factors as with the roll to stop factors but here to compute an increased thrust level for crossing a runway or taxiway. Thus, the universal factor units 240 to 246 may be used here as well. The roll to stop factors for roll factor units 250 to 256 also are the same or similar to expedite factors 260 to 266, except that instead of a pre-idle thrust, a pre-hold point thrust is provided by a pre-hold point thrust unit 262 to provide the actual thrust of the aircraft just before the aircraft reaches an expedite point (or holding point or hold short point) where thrusters are to be increased to cross the runway or taxiway. In addition, the expedite factors include a cross traffic factor unit 268 and a cross distance unit 269, where the cross traffic factor unit 268 provides the data of cross traffic and specifically when non-ownship aircraft will reach the intersection adjacent or near the target destination of the ownship aircraft. The cross distance unit 269 provides the width of the route or intersection (or runway or taxiway) being crossed until the ownship aircraft is out of the path of crossing traffic.

The expedite thrust unit 292 computes the thrust level, which may be a maximum ground thrust level for the aircraft, that should be used to at least avoid contact with crossing traffic, but otherwise by another example may continuously maintain a minimum separation length between the ownship and crossing aircraft. This expedited crossing algorithm may use the cross distance and the ownship aircraft speed to determine the time it will take for the aircraft to cross the runway or taxiway, then add that time to the expected time of arrival at the target destination point of the ownship aircraft, and compare that timing to the timing of the cross traffic at the intersection with the target destination.

For the single engine (or ‘power on’) instructions for the single engine taxiing, and in addition to universal factor units 240 to 246, additional single engine factors of single engine units 238 may include an A/C specification unit 260, an engine state unit 272, an ambient temperature unit 274, and a current thrust unit 276. The engine specification unit 270 may include factors or coefficients that represent the engine type, size, and configuration for those engines that have reduced spool up, faster startup, and/or reduced thermal stress capabilities. Smaller engines also tend to warm up more quickly than larger engines. There also may be minimum warm-up times provided in an aircraft's specifications or manuals. The fuel may be factored when the fuel type effects the time for an engine to reach stable takeoff operation. Also, aircraft electrical and pneumatic systems such as an Auxiliary Power Unit (APU) may be used to warm-up the engines for faster transition to be takeoff ready. Otherwise, an engine control system, such as a Full Authority Digital Engine Control (FADEC) systems, may be used to increase efficiency in the startup process, thereby reducing the warm-up duration.

The engine state unit 272 provides the current thrust and power state of both the on and off engines of the aircraft in the single engine taxi mode, and may include how long an engine has been powered off to indicate a cold or hot start.

The ambient temperature unit 274 provides a factor to represent whether weather will significantly extend the warm-up time. The electrical systems mentioned above may have pre-heating devices as well.

While using these factors, the ‘power on’ distance unit 294 computes the distance from a power on point and to a takeoff point that is the target destination on a runway. The engine that is off should be powered on at the ‘power on’ point for full use by the time the aircraft reaches the takeoff point. Determining this ‘power on’ distance is accomplished by determining the time needed to warm up the engine using the factors mentioned above, and then determining the distance the aircraft can travel in that time by factoring the motion related factors, such as speed and the current thrust level just before reaching the “power on” point. Many other algorithms may be used instead.

Referring to FIG. 3, a process 300 of generating real-time GN guidance instructions is described in accordance with at least one of the implementations herein. The process 300 includes operations 302 to 326, generally numbered evenly. Systems, devices, modules, units, and images of any of FIGS. 1-2 and 4-10 may be referred to while describing process 300, where relevant.

As a preliminary matter, the RTGNG system 200 may be activated automatically upon activation of one or more avionics systems or other system on the aircraft, but otherwise may be activated manually by a virtual or physical switch operated by the aircrew of a current aircraft (or ownship).

Process 300 may include “determine airside end-destination” 302, where an airside end-destination such as a runway, a terminal gate, a hanger, or other point on the airside may be provided through clearances or other sources. This is in contrast to a target destination that may be any holding point, hold short point, or other runway point (such as a takeoff point) as explained herein. The clearances announcing the end-destinations may be recognized directly by the speech unit 204 or may be manually input into an avionics system by a pilot to be part of the current aircraft operating context as well as for other uses by avionics systems for example.

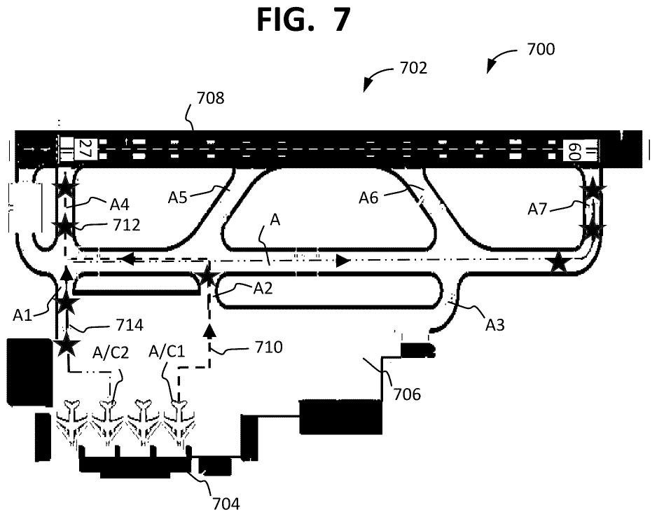

Referring to FIG. 7 as an example airside, an airport 700 has an airside 702 with a bi-directional runway 708 including runway (RWY) 27 from the left and RWY 09 from the right of the airside 702. A taxiway (TWY) A branches into taxiways A1, A2, and A3 to apron 706 amid terminal buildings 704, and branches A4, A5, A6, and A7 to runways 27 and 09. An aircraft A/C1 on apron 706 may receive taxiway route 710 with instructions to RWY 27 as the end-destination as shown in dashed line, while A/C2 has taxiway route 714 with instructions to RWY 09 as the end-destination shown in dash-dot-dot lines. The stars 712 are holding points or hold short points. Thus, the stars 712 may be brake locations to be performed, although this may include to decelerate for turns. In the present process 300, the real-time GN instructions may be provided to perform a roll to stop or expedited thrust at any of the holding point locations 712.

Process 300 may include “receive aircraft current operating context data” 304. Here the data from aircraft profile unit 222 (or aircraft operating context data) may be collected and from many different sources and networks as described above. This includes collecting the current aircraft operating context from avionics systems and/or any other sensor system on the aircraft that is recording the positions, motion, flight control settings, component states, and so forth on the aircraft. This also may include aircraft operating context data additionally or alternatively from other sources such as with weather or other environmental and surface conditions near the aircraft or airport. The aircraft operating context may be formatted in a format expected by the taxi model, and may be received continuously (or at some interval, such as every 10 microseconds) from the aircraft profile unit 222 or other systems using sensors and any other monitoring devices.

Process 300 may include “receive real-time airport airside context data” 306, and this real-time airport airside context data, also referred to as real-time ground operations data, may be obtained from the clearance monitor 212 and/or the traffic unit 220, as well as the aircraft profile unit 222. Thus, this operation 306 may include “clearances” 308 where any clearance-type messages are converted into data that indicate taxi routes, initial holding instructions, destinations, and so forth. Operation 306 also may include “traffic” 310 that collects traffic data indicating non-ownship aircraft positions, routes, timing, and so forth as described above at the airport airside. The monitoring of the airside also may be continuous (or at small intervals) by the monitoring methods and devices described above.

Process 300 may include “determine guidance procedures” 312, and this includes determining real-time GN instructions which refers to ‘real-time’ since the airside data is collected in real-time. This operation 312 may include “compute target time of arrivals at individual holding points” 314. In other words, the GN instructions described herein each depend, at least partly, on an estimated time of arrival (ETA) at a target destination as explained below. This involves determining the taxi route for an aircraft and obtaining or computing an estimated time of arrival at the airside end-destination point from the clearance data or flight plan mentioned above, such as a runway for an aircraft at a terminal. The holding points (or target destinations) for the aircraft along the taxi route is then obtained and the holding point locations are typically standard for each airport. The estimated time of arrivals (ETAs) of each holding point (or destination) is then determined. This may include determining the likely speed of the aircraft from holding point to holding point, which may or may not be instructed by the airport, ATC, or other entity. The ETAs may be determined by the FMS 128, flight plan unit 230, or the taxi guidance generator unit 214 itself, or other unit or system.

Operation 312 may include “determine which GN guidance instructions to generate” 315. This may be an automatic determination by the taxi guidance generator (TGG) unit 214 or other unit or system. Each of the available GN instructions may include a planned state of one or more engines of the aircraft whether that is to power on a second engine during single engine taxi, set the engines to idle thrust for a roll to stop instruction, or increase thrust for an expedite instruction. The instructions also may provide a planned distance along an airside route and before or behind the airside or target destination that the planned engine state is to be implemented.

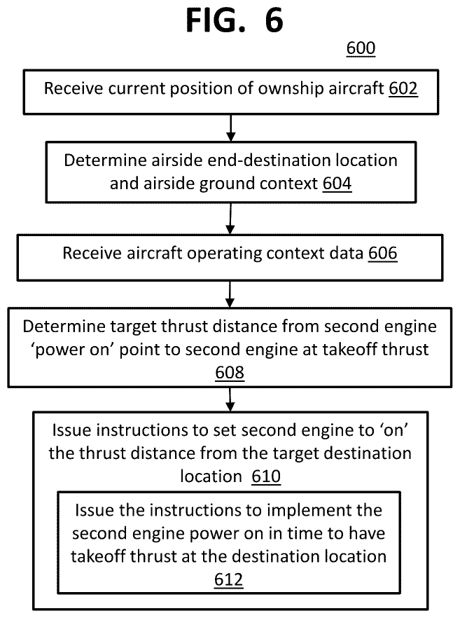

By one form, the TGG unit 214 may determine that the aircraft is performing a single engine taxi by receiving the engine states of the aircraft and is heading tom, or is on, a runway for takeoff. In this case, the single engine instructions may be provided before the takeoff point on the runway, where the takeoff point is the target destination. The generation operation 320 of the instructions for the single engine taxi instructions are provided with process 600 (FIG. 6).

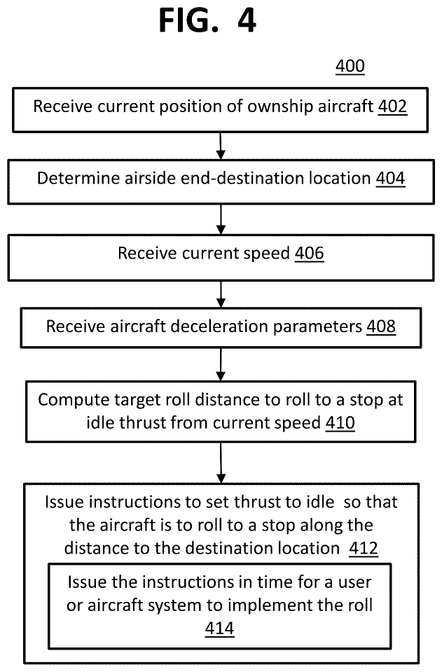

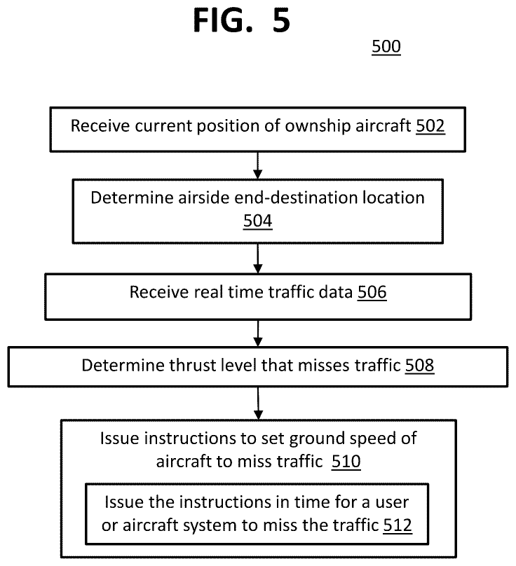

In addition, the TGG unit 214 may monitor the traffic of the airside or near the ownship aircraft along a taxi route assigned to the aircraft. In this case, and with the estimated time of arrivals, the TGG unit 214 will compare the timing of the aircraft with the surrounding traffic so that for each or individual holding point along the route of the aircraft with a crossing runway or taxiway, the TGG unit 214 may determine whether the aircraft will be able to cross the runway or taxiway without interfering with crossing traffic as mentioned above, or whether the aircraft will need to stop to permit non-ownship aircraft to cross on the crossing runway or taxiway first before proceeding. If the aircraft should stop, the roll to stop instructions will be generated at operation 316 and as described below with process 400 (FIG. 4). Otherwise, when the aircraft can proceed, the expedited crossing instructions may be generated at operation 318 and by process 500 (FIG. 5) described below.

After the GN instructions are generated including a distance value and/or thrust value as mentioned above, process 300 next may include “provide guidance procedures to aircraft” 322. This may include “display to aircrew” 324, which may include transmitting the GN instructions or parts thereof to the avionics or other systems on the aircraft to display the GN instructions on the display device 120 on the aircraft or a mobile display device 104 to show the GN instructions to the pilot for confirmation and execution when desired. The GN instructions also may be displayed to the ATC or other entity controlling aircraft traffic at an airside including airport tower personnel and/or ground personnel on the airside. Otherwise as another alternative, multiple alternative GN instructions for different situations may be provided on at least one display screen, and the pilot may have the option to select which procedures to confirm and execute.

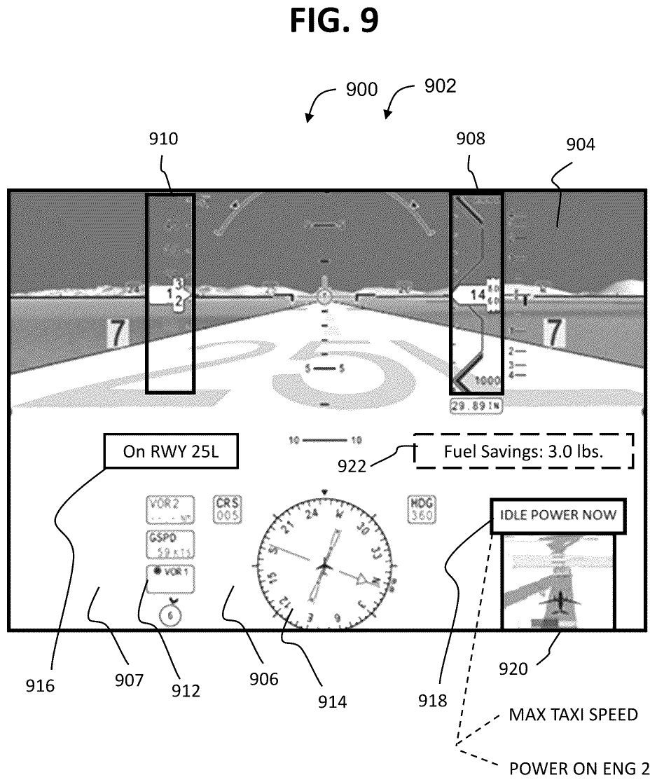

Referring to FIG. 9 for the display example, a forward perspective flight display 900 on a display device 902 shows a primary flight display (PFD) or other avionics display of an airport airside 906 and showing a runway (RWY) 25L designated as 907. This PFD display 904 has gauges including an altitude tape 908, a speed tape 910, and a compass 914. A route identifier window 916 identifies the runway number. Other windows and gauges 912 show other parameters or selections, here being ground speed (GSPD), and a VHF omnidirectional range (VOR) selection to select among different navigation (NAV) signals providing messages from different sources.

Most relevant here, the display or image 904 may have a zoom-out 3D window 920 showing the ground situation including a crossing runway ahead of the aircraft down the RWY 25L. A GN instruction window 918 shows relevant GN instructions determined from the real-time factor data mentioned above and that may provide the pilot an instruction to perform immediately or at a certain later time in regard to a next target destination that is a holding point, hold short of an intersection, or takeoff point as described above. When the aircraft reaches the roll to stop point the computed roll distance before a roll to stop destination, the GN instruction window 918 may show “IDLE POWER NOW” for the pilot to immediately move thrusters to idle or engines to Idle. Otherwise, the GN instruction window may show “MAX TAXI SPEED” when the aircraft reaches a destination and is to cross a runway or taxiway while avoiding traffic. Finally, the GN instruction window may show “POWER ON ENG 2” at the computed power on distance from a takeoff destination, and for the pilot to immediately power on the second engine. It will be understood that the message can be customized for a particular aircraft such as for three or four engines. Other instructions may be provided in the GN instructions window 918 instead, particularly timing instructions for approaching a destination, such as being at a certain thrust before the roll to stop point and idle thrust point. Many variations are contemplated as long as the real-time GN instructions can be provided in time and before the aircraft reaches a point on the airside where the instructions are to be implemented. By one example, the pilot may confirm the instructions which are first sent to the FMS 128 and then for autopilot or autothrust to perform the GN instructions.

By another example, an efficiency window 922 may be provided that receives the amount of fuel savings (or fuel consumption reduction) as shown and that may be computed by the performance unit 228 or other unit. By other alternatives, the efficiency window 922 made show efficiency measurements, time delay reductions, or other performance metrics relevant to the GN instructions being displayed.

As another example approach, operation 322 may include “provide to avionics systems” 326. Here, the GN instructions may also, or alternatively, be provided directly to the avionics or FMS systems on the aircraft for automatic execution without pilot confirmation, although the confirmation requirement may depend on the type of guidance procedure or instruction involved. This may include starting the roll earlier than initially planned when urgent to avoid contact between the aircraft and another object.

Referring now to FIG. 4, a process 400 of providing GN guidance instructions for an aircraft to roll to a stop at idle thrust is described in accordance with at least one of the implementations herein. The process 400 includes operations 402 to 414, generally numbered evenly. Systems, devices, modules, units, and images of any of FIGS. 1-3 and 5-9 may be referred to while describing process 400, where relevant.

Process 400 may include “receive current position of ownship aircraft” 402, and as provided to the taxi model 232 by the aircraft profile unit 222 as part of the aircraft operating context data, and that may be confirmed by the traffic unit 220. As some examples, the position may be provided by a GPS or other positioning system used by the FMS 128 and flight plan unit 230. This is already described with operation 304.

Process 400 may include “determine airside end-destination location” 404, and this may be provided from the airside context unit 202 as part of the real-time ground operations data, and specifically as instructed in the clearance data or as part of the taxi applications 210 providing taxi routes as described above with the clearance monitor 212. This was already part of operations 302 and 306.

Process 400 may include “receive current speed” 406, also received from the FMS 128 or flight plan unit 230 as part of the aircraft operating context data described above, or by other units of the real-time GN guidance system 200.

Process 400 may include “receive aircraft deceleration parameters” 408, and this includes any of the other computed or obtained roll factors of roll units 234 and in the form of factor values, and may be parameters that represent some range of values (such as a strength of drag as one example). This may be provided for each different factor, or other representations may be used instead.

Process 400 may include “compute target roll distance to roll to a stop at idle thrust from current speed” 410, and this is computed by the taxi model 232, and specifically the roll distance unit 290 with the kinetic energy or other algorithm as described above.

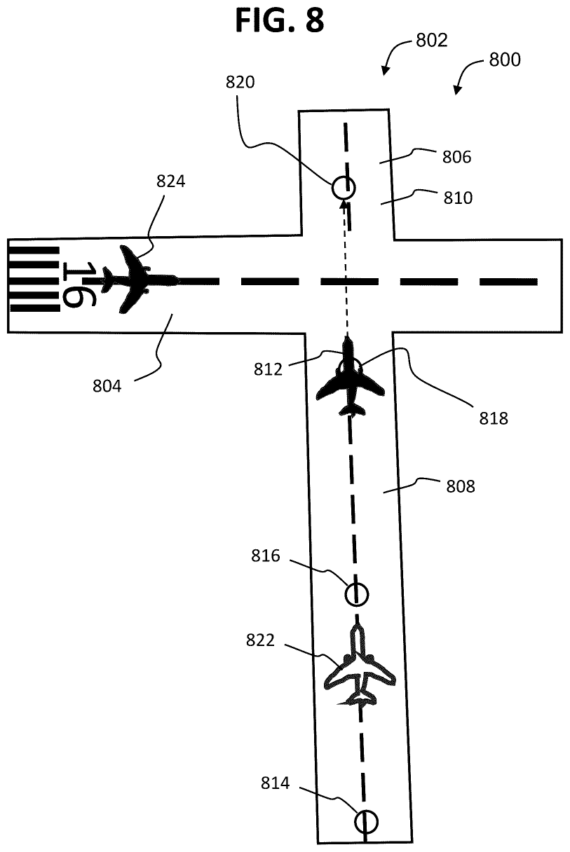

Referring to FIG. 8 as a roll to stop example, an airport 800 has an airside 802 used for an example generation of GN instructions, here being roll to stop instructions for process 400. The airside 802 has a runway RWY 16 804 that crosses a taxiway 806. For this roll to stop example, an ownship aircraft 822 is on a near side 808 of the taxiway 806 with a route that crosses the runway RWY 16 to reach a far side 810 of the taxiway 806. Ignore the aircraft 812 for now. A non-ownship aircraft 820 is ready to takeoff on RWY 16 and will cross the taxiway 806. In this example, the ownship aircraft 822 has traveled from point 814 and is heading to holding point 818. The taxi model 232 has determined the roll to stop distance for the aircraft 822 is from an idle thrust point 816 to the target destination point 818.

Process 400 may include “issue instructions to set thrust to idle so that the aircraft is to roll to a stop along the distance to the destination location” 412. Continuing the example of airside 802, and just before or when the aircraft reaches the idle thrust point 816, the display 120 will show the instructions to immediately change to idle thrust as described above with FIG. 9. Thus, operation 412 may include “issue the instructions in time for a user or aircraft system to implement the roll” 414. This refers to showing the instructions to the pilot on the display 120 and image 904 in time for the pilot to change the thrust from a current thrust level to idle thrust. Thus, the result will be that the plane rolls or coasts to a stop at the target destination point 818 to permit the aircraft 824 to pass on RWY 16.

Referring to FIG. 5, a process 500 of providing GN guidance procedures for an aircraft to expedite travel through crossing traffic is described in accordance with at least one of the implementations herein. The process 500 includes operations 502 to 512, generally numbered evenly. Systems, devices, modules, units, and images of any of FIGS. 1-4 and 6-9 may be referred to while describing process 500, where relevant.

Process 500 may include “receive current position of ownship aircraft” 502, as described with operation 402 (FIGS. 4) and 304 as part of the aircraft operating context data.

Process 500 may include “determine airside end-destination location” 504, and as described with operation 404, and operations 302 and 306 as part of the real-time ground operations data.

Process 500 may include “receive real-time traffic data” 506, and from the traffic unit 220 to receive the timing of the traffic potentially entering an intersection near a target destination of the ownship aircraft as described above.

Process 500 may include “determine thrust level that misses traffic” 508, and determined by the taxi model 232 as described above that analyzes the traffic timing to generate a thrust level expedite instruction for the ownship aircraft to implement at the target destination (or holding point or hold short point). This may be performed by the taxi model 232 using the expedite factors or factor units 236 to determine the thrust level for the expedite instruction to be generated, and as described above with the expedite thrust unit 292.

Referring to FIG. 8 again for example, and in the expedited case, the aircraft 812 reaches the expedite or hold short point 818 as the target destination. The generated instructions are a thrust level, such as a maximum taxi thrust, or other desired increased or maintained thrust, for the aircraft 812 to cross the RWY 16 while avoiding the aircraft 824.

Process 500 may include “issue instructions to set ground speed of aircraft to miss traffic” 510, and as described with avionics display 904 (FIG. 9 above), the avionics display 904 may show the GN instructions to a pilot to immediately increase thrust to a certain level (or maintain thrust) to cross the RWY 16 before the non-ownship aircraft 824 reaches the intersection with the taxiway 806. Operation 510 may include “issue the instructions in time for a user or aircraft system to miss the traffic” 512, where the instructions may be displayed just before the aircraft 812 reaches the destination point 818 when desired and to factor pilot reaction time.

Referring to FIG. 6, a process 600 of providing GN guidance procedures for an aircraft to perform single engine taxiing is described in accordance with at least one of the implementations herein. The process 600 includes operations 602 to 612, generally numbered evenly. Systems, devices, modules, units, and images of any of FIGS. 1-5 and 7-9 may be referred to while describing process 600, where relevant.

Process 600 may include “receive current position of ownship aircraft” 602, and as explained above with operation 402 and 502.

Process 600 may include “determine airside end-destination location and airside ground context” 604, and as described above with operations 404 and 504 as to the destination and that forms the real-time ground operations data. This includes the runway to be used and the target takeoff point in a single engine instruction example as here.

Process 600 may include “receive aircraft operating context data” 606, and this may include the single engine factors of single engine units 238 for power on of the second engine as listed on taxi model 232.

Process 600 may include “determine target thrust distance from second engine ‘power on’ point to second engine at takeoff thrust” 608, and as determined by the power on distance unit 294 of the taxi model 232 by using the single engine factors of single engine factor units 270 to 276. Here, the desired engine warm-up duration is determined (or looked up in specifications) and the power is turned on at the planned distance from the takeoff point and at the ‘power on’ point so that the second engine is ready to accelerate at the takeoff point and at a takeoff thrust.

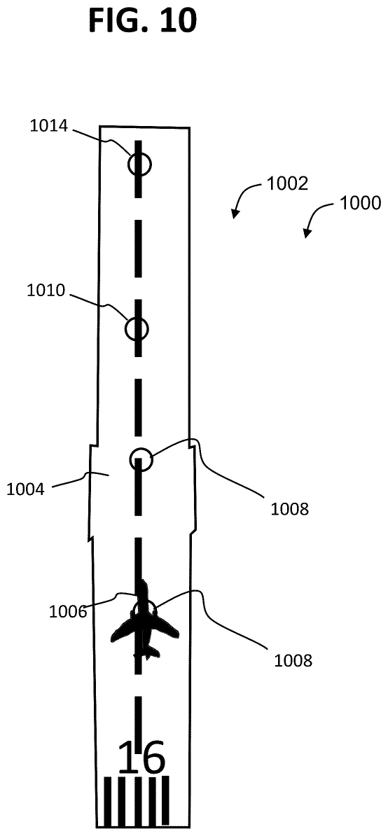

Referring to FIG. 10 for a single engine example, an airport 1000 has an airside 1002 with a runway 1004. An aircraft 1006 is moving from a current point 1008 and toward a takeoff point 1010, and is using single engine taxiing. The thrust distance is from a ‘power on’ point 1012 and to the takeoff point 1010 and that is the distance needed for a second engine to warm up and be ready to set to a takeoff thrust and accelerate at the takeoff point to a rotation speed at lift point 1014.

Process 600 may include “issue instructions to set second engine to ‘power on’ at the thrust distance from the target destination location” 610, where the GN instructions for power on are provided as described above with display 904 (FIG. 9), and operation 610 may include “issue the instructions to implement the second engine power on in time to have takeoff thrust at the destination location” 612. Thus, the instructions may be provided as the aircraft reaches the ‘power on’ point or slightly before to provide a delay for a pilot to read and implement the instructions at the ‘power on’ point.

It will be appreciated that the various illustrative logical blocks, modules, circuits, and algorithm operations described in connection with the implementations disclosed herein may be implemented as electronic hardware, firmware, computer software, or any combination of these. Some of the implementations and implementations are described above in terms of functional and/or logical block components (or modules) and various processing operations. However, it should be appreciated that such block components (or modules) may be realized by any number of hardware, software, and/or firmware components configured to perform the specified functions. To clearly illustrate this interchangeability of hardware and software, various illustrative components, blocks, modules, units, circuits, and operations have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention. For example, an implementation of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that implementations described herein are mere example implementations.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an implementation of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” or “units” in order to particularly emphasize their implementation independence. For example, functionality referred to herein as a module or unit may be implemented wholly, or partially, as a hardware circuit comprising custom VLSI circuits or gate arrays, off-the-shelf semiconductors such as logic chips, transistors, or other discrete components as described above. A module or unit may also be implemented in programmable hardware devices such as field programmable gate arrays, programmable array logic, programmable logic devices, or the like. Modules or units may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module or unit and achieve the stated purpose for the module or unit. Indeed, a module or unit of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process operations must be performed in a temporal or logical order according to such sequence unless it is specifically defined by the language of the claim. The process operations may be interchanged in any order without departing from the scope of the invention as long as such an interchange does not contradict the claim language and is not logically nonsensical.

Furthermore, the foregoing description may refer to elements or nodes or features being “coupled” or “connected” together. As used herein, unless expressly stated otherwise, “coupled” and “connected” refers to one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one example implementation has been presented in the foregoing detailed description of the invention, it should be appreciated that a vast number of variations exist. It should also be appreciated that the exemplary implementation or exemplary implementations are only examples, and are not intended to limit the scope, applicability, or configuration of the invention in any way. Rather, the foregoing detailed description will provide a convenient road map for implementing an exemplary implementation of the invention. It being understood that various changes may be made in the function and arrangement of elements described in an exemplary implementation without departing from the scope of the invention as set forth in the appended claims.

What is claimed is:

1. A method, comprising:
determining, by at least one processor, a target destination at an airside at an airport and of an aircraft;
receiving aircraft operating context data indicating a current state of the aircraft and including at least a current position of the aircraft;
receiving real-time ground operations data for the airport and from at least one real-time data source including instructions to move the aircraft to the target destination;
determining, by at least one processor, ground navigation instructions by using both the real-time ground operations data and the aircraft operating context data, wherein the ground navigation instructions recite a planned state of one or more engines of the aircraft; and
providing the ground navigation instructions in time to implement the ground navigation instructions so that the one or more engines of the aircraft are in the planned state at or before reaching the target destination as instructed by the ground navigation instructions.

2. The method of claim 1, wherein the planned state is an idle thrust to be initially implemented a planned distance along a route before the target destination and maintained along a distance to cause the aircraft to roll to a stop to the target destination.

3. The method of claim 2, comprising computing the planned distance comprising using at least a speed of the aircraft and a weight of the aircraft.

4. The method of claim 1, wherein the planned state is an expedited thrust level to be implemented at the target destination and maintained as a minimum to cross at least one runway or taxiway at the airside to avoid crossing aircraft traffic.

5. The method of claim 4, wherein the aircraft operating context data includes a speed and position of the aircraft, and wherein the real-time ground operations data comprises at least one of position, speed, and route of at least one non-ownship aircraft of the crossing aircraft traffic.

6. The method of claim 1, wherein the planned state is a power on state of at least one second engine initially at a power off during single engine taxiing by a first engine of the aircraft, wherein the power on state is to be implemented before reaching the target destination so that the at least one second engine is ready to set a takeoff thrust level at the target destination to accelerate to rotation speed at lift-off after reaching the target destination.

7. The method of claim 6, wherein the aircraft operating context data comprises a current state of the first and second engines, a length of time the power of the second engine has been off, and engine identification that indicates a desired duration of warm-up, and wherein the real-time ground operations data comprises ambient temperature.

8. The method of claim 1, comprising displaying at least part of the ground navigation instructions on an avionics display viewable by an operator of the aircraft and indicating which ground navigation instruction to implement and when to implement the ground navigation instruction.

9. The method of claim 1, comprising displaying at least a part of the ground navigation instructions at a time the part of the ground navigation instructions is to be implemented.

10. The method of claim 1, comprising providing the ground navigation instructions to at least one avionics system on the aircraft to be implemented autonomously.

11. A system, comprising:
memory; and
processor circuitry forming at least one processor communicatively coupled to the memory and being arranged to operate by:
determining a target destination at an airside at an airport and of an aircraft;
receiving aircraft operating context data indicating a current state of the aircraft and including at least a current position of the aircraft;
receiving real-time ground operations data for the airport and from at least one real-time data source including instructions to move the aircraft to the target destination;
determining ground navigation instructions by using both the real-time ground operations data and the aircraft operating context data, wherein the ground navigation instructions recite a planned state of one or more engines of the aircraft, where the planned state is at least one of a thrust level or a power on/off state; and
providing the ground navigation instructions in time to implement the ground navigation instructions so that the one or more engines of the aircraft are in the planned state at or before reaching the target destination as instructed by the ground navigation instructions.

12. The system of claim 11, wherein the processor is arranged to operate by determining which type of ground navigation instructions to provide depending on the current position of the aircraft along an airside route of the aircraft relative to at least one upcoming target destinations and non-ownship aircraft traffic along a same or crossing airside route as the aircraft.

13. The system of claim 12, wherein the aircraft is an ownship aircraft, and wherein the ground navigation instructions comprise instructions to roll to a stop at a holding point when non-ownship aircraft traffic will block the airside route of the ownship aircraft, and comprise an expedite instruction to increase thrust when reaching a holding point when the ownship aircraft is clear to cross a runway or taxiway without interfering with non-ownship aircraft traffic.

14. The system of claim 12, wherein the processor is arranged to operate by instructing the aircraft to roll to a stop at multiple target destinations each being a holding point along an airside route of the aircraft.

15. The system of claim 12, wherein the processor is arranged to operate a taxi model that plans rolls to a stop and expedited crossings before the aircraft reaches any of multiple target destinations each being a hold short stop along an airside route and by predicting aircraft traffic along the airside route.

16. A non-transitory computer-readable medium comprising instructions thereon that when executed by a computing device, cause the computing device to operate by:
receiving an end-destination at an airside of an airport and a route from a current position of an aircraft and to the end-destination;
determining at least one target destination along the route and of the aircraft;
receiving aircraft operating context data indicating a current state of the aircraft;
receiving real-time ground operations data for the airport and from at least one real-time data source including instructions to move the aircraft to the target destination;
determining ground navigation instructions by using both the real-time ground operations data and the aircraft operating context data, wherein the ground navigation instructions recite a planned state of one or more engines of the aircraft; and
providing the ground navigation instructions in time to implement the ground navigation instructions so that the one or more engines of the aircraft are in the planned state at or before reaching the target destination as instructed by the ground navigation instructions.

17. The medium of claim 16, wherein the instructions cause the computing device to operate by providing multiple ground navigation instructions each to move the aircraft to a different one of multiple target destinations, wherein each target destination is a holding point along an airside route of the aircraft, and determining an estimated time of arrival (ETA) at each target destination.

18. The medium of claim 16, wherein a roll to a stop ground navigation instruction is determined by factoring aircraft drag, pre-idle thrust of the aircraft before the aircraft reaches an idle thrust point along a route to the target destination, a surface condition of the airside, a wind condition at the airside, a brake condition of the aircraft, and a roll resistance of the aircraft.

19. The medium of claim 16, wherein an expedite ground navigation instruction is determined by factoring aircraft drag, pre-target destination thrust of the aircraft before the aircraft reaches the target destination, a surface condition of the airside, a wind condition at the airside, cross traffic data indicating a presence of at least one non-ownship crossing a route of the aircraft near the target destination, and crossing distance being a width of a route of crossing traffic.

20. The medium of claim 16, wherein the instructions cause the computing device to operate by displaying, on an avionics display viewable by an operator of the aircraft, at least an indication of a potential change in fuel consumption or time delay to be caused by implementing the ground navigation instructions.
